(19) United States
(12) Patent Application Publication
(10) Pub. No.: US 2005/0044906 A1
(43) Pub. Date: Mar. 3, 2005

(54) Method and system for setting entry codes via a communications network for access to moveable enclosures

(76) Inventor: Timothy G. Spielman, Calgary (CA)

Correspondence Address: KATTEN MUCHIN ZAVIS ROSENMAN, 525 WEST MONROE STREET, CHICAGO, IL, 60661-3693, US

(21) Appl. No.: 10/626,797

(22) Filed: Jul. 25, 2003

(51) Int. Cl. G06F 7/00; E05B 65/48

(52) U.S. Cl. 70/63; 340/5.7; 340/5.5

(57) ABSTRACT

A system and method for controlling access to a moveable enclosure are provided. The system includes a lock on the moveable enclosure, a control circuit coupled to the lock and configured to i) receive an entry code and ii) open the lock in response to receipt of the entry code, a time measurement device and/or Global Positioning System device coupled to the control circuit and configured to generate time and position data, such as latitude and longitude data, relating to the moveable enclosure; and a personal computing device wirelessly coupleable to the control circuit and configured to generate the entry code using the latitude and longitude data. The entry code may be erased after a single use. The validity of entry code may depend upon the time of its entry and the physical location of the moveable enclosure.

### BACKGROUND OF THE INVENTION

1. Field of the Invention

The present invention relates to a method and system for setting entry codes over a communications network such as the Internet for access to moveable enclosures.

2. Description of the Related Art

Conventionally, entry to moveable enclosures (such as ships, trucks, etc.) is limited to plastic tags or metal pins to detect tampering of the contents. The pins and tags are obviously more secure than no lock, but the tags and pins are easily removed and either replicated and replaced.

A partial solution used in some high security instances for moveable enclosures is to have a padlock or combination lock. However, the key and combination locks cannot identify who is gaining access to the moveable enclosure, nor can they identify where the moveable enclosure is or where and/or when it should be opened.

Another weakness is that the operator driving, transporting, or towing the moveable enclosure must be trusted to ensure the contents are not tampered with. Given the fact that many of the drivers have not been effectively screened or bonded to ensure that they should be trusted with the contents of the moveable enclosure, and given the fact that many of the drivers are contracted on a per-haul basis, it is a vast security improvement to remove the driver from the security of entries and exits to and from the moveable enclosure. A partial solution is to bond the drivers. However, this does not provide for the monitoring or tracking of entries into and exits from the moveable enclosure.

Accordingly, there is a need for a system that would provide for one or more of securing a moveable enclosure, tracking who is gaining access to the moveable enclosure, monitoring the location of the moveable enclosure, and determining when and where the moveable enclosure should be able to be opened.

### SUMMARY OF THE INVENTION

The present inventor has provided a new and novel method and system for securing moveable enclosures. In a preferred embodiment, the system includes the combination of a lock (for example, a wireless digital remote control lock), coupled to a software program on a general purpose computer (e.g., a “PC”) that is remote from the moveable enclosure to monitor and communicate to and from the lock, and to create entry codes to be sent to the lock. The lock is physically separated from the PC, but the lock is electronically coupled to the PC so that the PC can monitor the status of the lock and produce an audit trail (i.e., tracking) of the lock activity. The PC can also be programmed to communicate events to and from the lock and generate entry codes for the lock.

In one aspect of a system for securing a moveable enclosure according to the present invention, a lock is permanently attached to the moveable enclosure, and the lock communicates with a software platform that is able to send entry codes and receive tracking and monitoring information. The system can be connected to any type or make of lock for any type or make of moveable enclosure.

In another aspect according to the present invention, the system provides for various types of locks that are transferable from one moveable enclosure to another moveable enclosure, similar to a keyed or combination padlock.

### BRIEF DESCRIPTION OF THE DRAWINGS

FIG. 1 is a schematic data flow diagram according to a preferred embodiment of the present invention.

FIG. 2 is a schematic block diagram that illustrates an electrical and electronic circuitry of the lock according to a preferred embodiment of the present invention.

FIG. 3 is a schematic block diagram that illustrates components of a lock control and communication station according to a preferred embodiment of the present invention.

FIG. 4 is a flow chart that illustrates a method of securing access to a moveable enclosure according to a preferred embodiment of the present invention.

### DETAILED DESCRIPTION OF THE INVENTION

The present invention provides a method and system for setting entry codes and monitoring and tracking the movement of enclosures over any form of communications network, such as the Internet or a private local or wide area network, for the purpose of regulating access to the moveable enclosures.

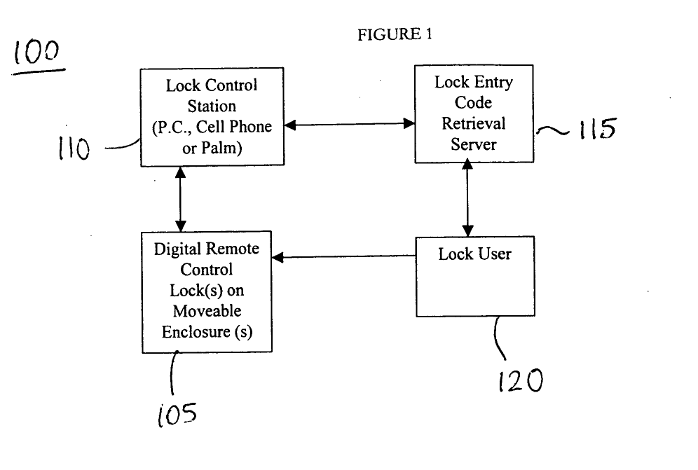

Referring to FIG. 1, a schematic block diagram for a security system 100 for controlling access to a moveable enclosure is shown. The system includes a digital remote control lock 105 on the moveable enclosure. The lock 105 is electronically coupled to a lock control station 110. The lock control station 110 may be a personal computer (PC), a cellular telephone, a personal digital assistant (PDA), or any other electronic device that can be used to provide electronic remote control to the lock 105. The lock control station 110 is coupled to a lock entry code retrieval server 115, which may physically reside with the lock control station 110, or may reside at a remote location. For example, a PC can be used to house both the lock control station 110 and the lock entry code retrieval server. In addition, the PC may use an intermediary device or a plurality of intermediary devices to connect to the lock. Examples of intermediary devices include another PC, a wireless hand-held device, a wireless router, a bridge, or another server to connect to the lock. The intermediary device may be situated between the lock control station 110 and the digital remote control lock 105 on the moveable enclosure. A lock user 120 (for example, a person who requires access to the moveable enclosure) communicates with the lock entry code retrieval server 115 in order to learn the appropriate entry code. For example, the lock user 120 may communicate with the server 115 via the Internet. Once the lock user 120 learns the appropriate entry code, the lock user 120 provides that entry code directly to the lock 105 in order to open the lock and gain access to the moveable enclosure.

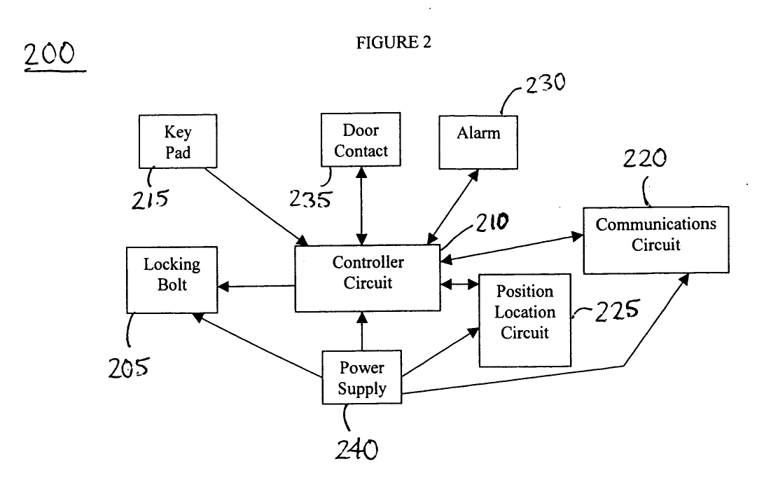

Referring to FIG. 2, a schematic block diagram illustrating an exemplary electronic circuitry 200 of a control circuit used by the digital remote control lock 105 is shown. A locking bolt 205, which may include a solenoid to throw the bolt, is connected to and controlled by a controller circuit 210, which is connected to a keypad 215 by electrical conductors. The controller circuit 210 is connected to a communications circuit 220 by electrical conductors. The controller circuit 210 is also connected to an enclosure position location circuit 225 by electrical conductors (not shown). In addition, there may be an alarm circuit 230 and a door contact circuit 235 to ensure that the lock 105 will not lock the moveable enclosure door in an open position. The alarm circuit may also activate if the locking bolt is broken or artificially disabled either physically or electronically. The keypad 215, the locking bolt 205, the communications circuit 220, the position location circuit 225, the door contact circuit 235, the alarm 230 and the controller circuit 210 are powered by a power supply 240. In addition, the controller circuit 210 may contain a hardware component and/or a software component to measure time. Alternatively, an additional time circuit could be added to the circuitry 200 (not shown).

The components illustrated in FIG. 2 include the following: The locking bolt 205 is used to latch closed or unlatch open the door on the moveable enclosure. The controller circuit 210 is the electronic circuitry that controls the entire process of controlling access to the moveable enclosure. The controller circuit 210 may either create the locking code or receive it from a manual or software driven process. The keypad 215 is the external keypad used to enter the entry code to open the door to the moveable enclosure. It is also used to lock the door after the delivery is made. Alternatively, the lock may automatically lock upon the closing of the door. This may be attributable to the physical construction of the lock, or it may be caused electronically via the controller circuit 210 working in conjunction with the door contact circuit 235. The communications circuit 220 is a wired and/or wireless device that allows for communication between the lock controller circuit 210 and the PC software 110 and 115. The position location circuit 225 is a wired and/or wireless device that is used to determine the physical location (e.g., GPS latitude and longitude coordinates) of the lock on the moveable enclosure. In the preferred embodiment, the position location circuit 225 comprises a GPS (Global Positioning System) receiver. The alarm 230 is an alarm mechanism that detects when the door is open and a proper code has not been entered or when the door is not closed and there is an attempt to lock the door. This alarm system can be either dedicated to the moveable enclosure or integrated with an external alarm system. The door contact circuit 235 is the contact for the door on the moveable enclosure that is used to ensure that it is closed for alarm purposes and for closing the door bolt. The power supply 240 is power to drive the entire process. It is a battery, wall power, wall power with battery back up, battery with wall power trickle charge and/or any combination of the above.

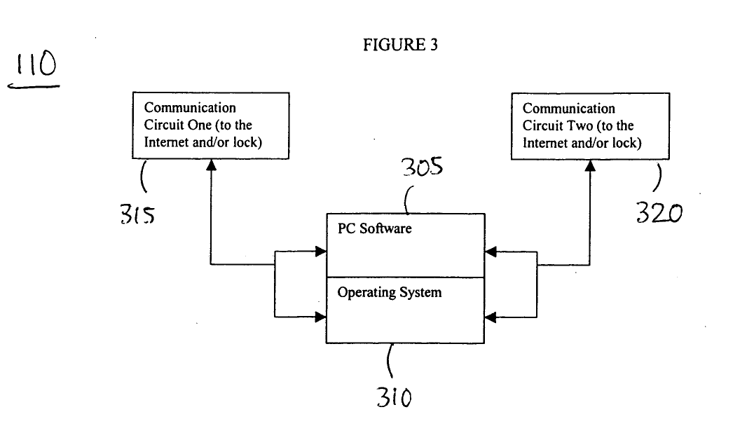

Referring to FIG. 3, a schematic block diagram illustrating components of a lock control and communication station 110 according to a preferred embodiment of the invention is shown. The PC software 305 is running on the operating system 310 of the PC. Alternatively, the PC software 305 may be built in or combined with the operating system 310. It is noted that some other form of computing device, such as a PDA or a cell phone, may be used instead of a PC. The PC software 305 is connected via software and hardware components to one or more communication modules 315, 320, which, for example, may be one or a plurality of wired and/or wireless network cards, that allow communication with the lock 105 and/or a communication network to communicate the lock entry codes to the lock user or users 120 via the lock entry code retrieval server 115. In addition, the communication modules 315, 320 may communicate through an intermediary device to the lock 105.

In general, the enclosure may be of any size that is moveable, either under its own power or moved by any other means. Such an enclosure may range from a toolbox to the space shuttle or any enclosure that is capable of movement. The movement can be within the enclosure itself, for example, it may change size or shape or mass or weight, or it may move in relation to its location on the earth, or anywhere else in the universe. In addition, the enclosure may change composition, for example, its atomic structure. Some possible configurations for the enclosure include:
(1) One or a plurality of toolboxes, briefcases, purses, laptop computers, personal stereos, cell phones, personal digital assistants (PDAs), Global Positioning System (GPS) units, luggage, books, backpacks, or other objects that are able to be carried; this may also include firearms and the safety mechanism used to lock or secure the firearm;
(2) One or a plurality of jackets or any clothing or device that can be worm, such as the new infantry suite that is equipped with many functions that could be restricted to its rightful owner or requires activation;
(3) One or a plurality of devices that are operated by artificial intelligence of any kind, including software or hardware, such as robots;
(4) One or a plurality of vehicles that can be driven or flown or otherwise transported by its own power. Examples include cars, trucks, motorcycles, heavy equipment, locomotives, ships, ship containers, shipping containers, barges or any other surface vessel, submarines, remote piloted vehicles (e.g. predator), robots (remote controlled), tanks or other self propelled guns, special purpose vehicles (e.g. cranes, boring and drilling equipment), drilling rigs, helicopters, airplanes, space planes, and rockets;
(5) One or a plurality of moveable components contained in, on, or around moveable enclosures regardless of how they move (i.e., up and down, in and out, materialize and dematerialize, or slide) in any direction. An example of such a moveable component is a door of any type on any type of moveable enclosure; and
(6) One or a plurality of vehicles that can be towed or moved by some other means. Examples include Intermodal containers, trailers (e.g., travel, mobile homes and truck trailers/18 wheelers), trailers used in remote locations (i.e., such as ATCO), towed guns (e.g., howitzers), heavy equipment such as drilling rigs, vessels or containers of any size and shape such as propane vessels mounted on the back of trucks, rail cars of all types, diving bells or other submerged vehicles, glider airplanes, space vehicles, and satellites of any kind that travel around any celestial body or that travel to and from celestial bodies, or any combination of the above, including communications satellites and the international space station.

Entry codes may include a variety of items. They can be biometric codes of any kind (examples include fingerprints and/or retinal scans), bar codes, radio frequency codes, infrared, proximity based, sound codes (one example is voice recognition), numbers, letters, digital signatures, public and private key generated codes, secret key generated codes, GPS-based location codes, implant sensors of any kind (an example is a dog collar injected microchips), wearable sensors and/or activators such as a Bluetooth™ device, or card devices such as smart cards, key fobs (e.g., the fob that locks and unlocks a door to an automobile), electronic keys, or any combination of the above. Entry codes may also be embodied as any combination of the above items, such as a biosensor and a Bluetooth™ device.

Entry codes can be generated to be unique to the entry event, unique to the shipment, unique to the lock, unique to the PC software, unique to a person, and/or unique to the enclosure. Entry codes can also be any combination of the above items; for example, an entry code may include a unique lock code and a unique person code.

Types and styles of entry codes include a single use code or a plurality of single use codes, a multi-use code or a plurality of multi-use codes, a time-based code or a plurality of time-based codes, and a GPS-based code or a plurality of GPS-based codes. This includes any type or version of global positioning technology used such as the European Galileo system. In addition, any combination of these types could be used as codes. An example is a single use GPS-based code where the entry code for the moveable container would only work once (i.e., single use) at one location as determined by GPS-based coordinates. A second example is the use of two codes that are multi-use and time based for an ATCO trailer. In the second example, the ATCO trailer has two entry codes that permit entry repeatedly during set periods of time. Each code could either have different time parameters or the same time parameters. Each code would be unique if it was operated using the same lock operating system.

The PC software system may include one or a plurality of digital remote control locks that are associated with the PC software system. In addition, a digital remote control lock may be associated with one or a plurality of PC software systems. The security system can also have any combination of the above, for example, there may be two PC software systems associated with the same three locks.

In one embodiment, the system is integrated with one or more of the following systems:
1. Electronic manifest system, for example, to record the contents contained within the moveable enclosure, or moveable enclosure(s) within moveable enclosure(s);
2. Location tracking system, for example, to track the movement of the moveable enclosure;
3. Mapping system or software, for example, to view the movement of the moveable enclosure on a reference map; and
4. Radio frequency tagging system and/or bar code scanning system, for example, to determine in real time the inventory present in the moveable container.
   Thus, the security system of the present invention may provide a lock that knows who should have access, where it should be, and what it should be protecting. The lock then keeps track of all of the events related to the above functions and communicates them back to the PC software. The relevant information may include a map of where the lock is, a showing of where and when events take place, and/or the contents loaded and unloaded from the moveable enclosure. This information could also include any combination of the above, or any events related to the lock on the moveable enclosure, for example, when the lock and moveable enclosure reach orbit, when they leave the seller, when they reach the buyer, or when they reach the border.

In another embodiment, mapping software may be integrated into the PC software to allow for the selection of a location for a GPS-based code to be used. The mapping software and the PC software would then convert the map location into GPS coordinates and transmit the coordinates to the lock on the moveable enclosure. Another feature of this functionality would allow the GPS-based entry code to work within a set area surrounding the GPS location. This is similar to setting a perimeter within which the GPS-based code would still allow the lock to open on the moveable enclosure. The size of the perimeter could be selected in a variety of ways, including preset sizes (e.g., one block radius, one mile radius, within the city, a square being from a set latitude plus or minus an amount and a set longitude plus or minus a set amount), or an artificial intelligence controller that corrects for the inaccuracies of the GPS system to know where the correct location should be (located in the lock), or the selection of a set size area on a map or mapping software using a mouse or some other pointing device or any other method for selection of geographic locations and areas using a PC or other computing device.

In yet another embodiment, the integration of actual GPS latitude and longitude coordinates is performed, and these coordinates are used to set GPS-based entry codes. A perimeter similar to that described above could also be set up using this embodiment as well.

In other embodiments, inventory manifest software may be integrated with the PC software. Therefore, the setting of moveable enclosure entry codes can be included in the creation of the manifest for the moveable enclosure, or the creation of the manifest is included in the setting of the moveable enclosure lock entry codes, or some combination of the above methods. The manifest may also include the pick up points and drop off points of the contents of the moveable enclosure, along with their related lock entry codes. This allows real time tracking of the contents in the manifest by determining where they are while securing the contents of the moveable enclosure. If the items to be loaded or unloaded from the moveable enclosure are equipped with identification components such as radio frequency tags, an additional component for recognizing when the items are added to or removed from the moveable enclosure may be added to the lock. Thus, the additional component confirms that the items in fact have been loaded or unloaded at the correct time and/or location using the correct entry codes. This feature also allows for more precise inventory management, such as for goods in progress, and it also allows for one or more pickups or drop-offs in one shipment.

In such a situation, an entry code to the moveable enclosure would only allow that lock user to remove a specific item or items from the moveable enclosure at a specific location within a specified time period. For example, the entry code may allow the lock user to remove one box of pens (i.e., specified items) from the truck (i.e., moveable enclosure) at a specific school (i.e., a set GPS location) between 11 a.m. and 12:00 noon (i.e., a set time which is the expected time for the delivery). Any combination of these parameters may be used. If additional items were removed, or the item was attempted to be delivered to the wrong location, or it was delivered at the wrong time, it would create an event that could set off the alarm. Each delivery and each alarm event would create an event that would be sent back to the PC software that may be integrated with the electronic manifest. The end result is that the user of the PC software would know exactly what items are in the moveable enclosure currently (or at any given point in time), which items have been delivered or picked up, when that occurred, and where it occurred as soon as it happens, or in near real time. In addition, this movement of goods could be used to automatically create a purchase or sales transaction, as there is proof that the items have been physically transferred to or from the moveable enclosure.

In one embodiment, the locks are wireless digital remote control locks having a processor, memory, software, and communications capability. This means that there is no way to generate or create an entry code at the lock. The entry codes can only be created from the PC software and be sent to the controller at the lock. The lock would then confirm that it has received the entry code back to the PC software. The decision as to whether or not the code is valid is determined by the controller at the lock. This means that if communication between the lock and the PC software is broken, the lock controller is still sufficiently intelligent to know if the entry code entered is still valid. If the code is determined to be valid by the controller at the lock, then the lock will be opened. If the controller determines the code to be invalid, the lock will not be opened. After three attempted invalid openings, the controller will lock out input from the keypad for 30 seconds. These events are recorded in the controller and communicated back to the PC by the controller at the next communication, which can be immediate, timed, scheduled, or initiated by the controller or by the PC software or any combination of the above. If the code is a one-time use code, it is erased from the controller. In this embodiment, it is erased prior to the door even being activated to be opened. In other embodiments, it could be later, or even upon the next communication with the PC software.

The moveable enclosure is preferably provided with a door contact sensor, which may be a magnetic reed switch or a magnet or any other electromagnetic, mechanical or other physical or electronic sensing equipment, or any combination of the above. The door contact sensor is connected to the controller circuit so that the controller circuit in any fashion, such as wired, wireless, or any other method, so that it can determine whether the door on the moveable enclosure is fully closed so that when the locking bolt latches it will properly engage the latch bracket to lock the door to the moveable enclosure. This prevents the door from being locked open.

The moveable enclosure is also preferably provided with an alarm that is connected to and controlled by the controller circuit. It also may be powered by the power supply or some other system. The alarm should preferably provide a sound or some other method of calling attention to an unauthorized entry to the moveable enclosure. The alarm would also preferably be under the control of the controller circuit. Openings may be provided in the moveable enclosure to allow the alarm to be heard more easily.

In another embodiment, the alarm and the door contact sensor system may be part of an existing alarm system and/or cabin pressurization system for the moveable enclosure such as an airplane, in which case the controller circuit may cause the alarm to take appropriate action (generate sound, light, a call to police, notify the government, notify the lock manager, etc.) in circumstances described below. If someone forces the door open without entering a valid entry code, the alarm is triggered.

In one embodiment, the lock on the moveable enclosure is integrated or connected to receive input from a camera or some monitoring apparatus that takes or displays video. This feature allows the lock manager to have a picture or video of the individual (or other artificial intelligence) entering an entry code before the entry of the code, during the entry of the code, and/or after the entry of the code, and at any time before, during, or after the entry into the moveable enclosure. If the picture or video is tied to face recognition software, this feature may be used in combination with an entry code to verify that it is the correct person and/or the correct entry code being used before entry is granted by the controller on the lock. In addition, this embodiment may include integration with one or a plurality of other sensor types, such as a motion detector.

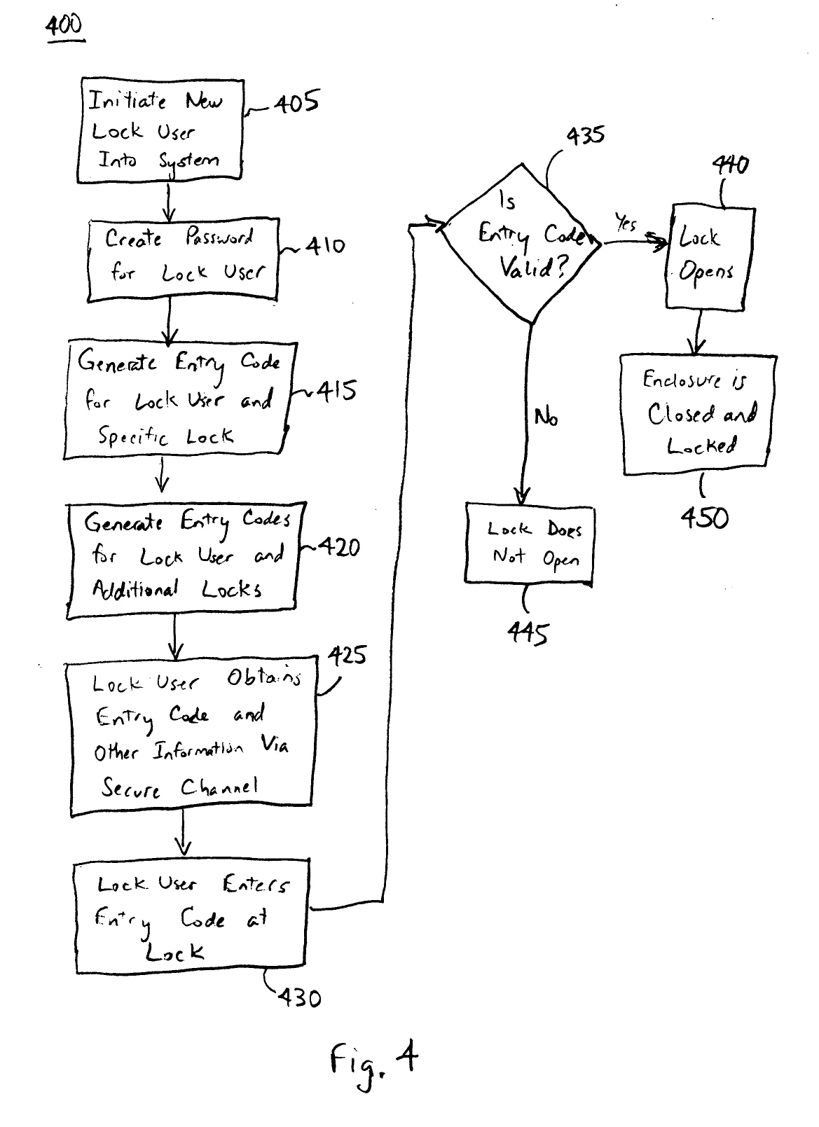

Referring to FIG. 4, in one embodiment, the process 400 of creating an entry code would be as follows:
1. At step 405, the lock manager, sitting at a PC using software designed for managing the lock(s) on the moveable enclosure(s), sets up a person(s) or artificially intelligent being(s) as a lock user(s). The PC software sends a message to the person(s) stating that he has been approved as a lock user for the lock manager's company or association or personal purpose. Included in the message is a user name, for example, the lock user's email address, a temporary password that may be randomly, manually, or semi-randomly generated using software on the PC software, and a website to visit to complete the setup of the lock user's account.
2. At step 410, the lock user visits the website and creates a permanent password that is unique to the lock user. The permanent password may be automatically generated, manually generated, or selected from a list. The permanent password may be subject to scrutiny to ensure the password is sufficiently strong or cryptic and that it includes a sufficient number of characters.
3. At step 415, the lock manager, using the PC software, then determines which lock(s) that the lock user is entitled to use, and creates a code for that user and that lock. The lock and the lock users may be selected from a list or provided in some other user-friendly manner. The PC software then sends a message to the lock user stating that a lock code has been generated for his use, and instructing the lock user to visit a secure website to obtain the lock code using his user name and permanent password. The PC software may use other methods, such as secure email, to send the lock code to the lock user. A key aspect of the invention is that the lock code is securely transmitted to the lock user electronically, physically, or some combination of the two. This aspect contrasts with the traditional method of arranging a meeting at a given time and place so that a swipe card or a key or a smart card can be physically transferred to the lock user. Instead of using a physical key, a digital key is provided via secure means, thus avoiding the asset management hassles and costs of physically transferring the key to the lock user.
4. At step 420, the lock manager, using the PC software, then determines any additional locks that the lock user is entitled to use, and creates codes for that user at those locks in much the same manner as described above. The lock manager may assign the same or different codes to each lock.
5. At step 425, the lock user, after receiving the message that a lock code has been generated for his use, visits the website, enters his user name and password (or any other verification method to ensure that the authorized lock user is actually the person that is retrieving the information) and views the entry code or codes that were created for him. The website also states the location and name of the lock and related moveable enclosure, and any other data deemed relevant to the lock user. Additional data that a lock user might want include directions to and from the moveable enclosure, where on the moveable enclosure the lock is found, or real time tracking of the moveable enclosure so as to calculate or otherwise determine (perhaps calculated by the PC software) a rendezvous point to meet up with the moveable enclosure, or an expected arrival time (ETA) at his or another location.
6. At step 430, the lock user proceeds to the moveable enclosure lock and enters the entry code generated for him and/or for that moveable enclosure. This may involve the entering of the entry code and an enter key, or simply entering the lock entry code, or any combination of events to verify the lock should open. At step 435, a determination is made as to whether the entered entry code is valid. If the entry code is correct, then at step 440, the lock controller will open the lock to the moveable enclosure and allow the lock user to gain access to the moveable enclosure. If the entry code is not correct, then at step 445, the lock will not open. Repeated attempts to enter incorrect entry codes will result in an alarm event being created and possibly the sounding of an alarm. The alarm event may be transmitted to the lock manager, the police, the government, and/or the border patrol to enable appropriate action to be taken with respect to the event, such as the dispatch of a border guard to impound the moveable enclosure to effect physical inspection at the border.
7. Upon the end of the visit to the moveable enclosure, at step 450, the lock user closes the door and presses the lock close button on the keypad. Alternatively, the lock may close automatically if all of the relevant components agree that the door should be locked. If the door is equipped with a door contact sensor and the sensor indicates the door is properly closed, then the lock engages and the moveable enclosure is closed. If the door contact sensor indicates the door is not properly closed, then it will not close. If there are repeated attempts to lock the door without it being closed, then an alarm event will be generated.

Assuming that an entry code has been set up in the controller circuit using the above system, the following describes a typical series of steps that would be required to be taken by a lock user upon entering the moveable enclosure:
(1) Lock User enters an entry code into the keypad.
(2) Controller circuit determines whether code is a valid entry code.
   (a) If the entry code entered by the lock user is valid, the circuit disarms the alarm and engages the locking bolt to unlock the moveable enclosure door. The entry code just used may be erased from the list of valid codes if the controller circuit provides such functionality.
   (b) If the entry code entered by the lock user is invalid, the controller circuit allows the lock user has two more attempts to enter a valid code before sounding the alarm.
(3) The lock user opens the door enters the moveable enclosure to visit it, occupy it, perform a service, or enters to place an item inside.
(4) Upon completion, the lock user closes the door to the enclosure, closing the door contact sensor.
(5) The lock user presses the lock key on the keypad.
   (a) If the controller circuit determines from the door contact sensor that the door is closed, the controller circuit actuates the locking bolt to lock the door and arms the alarm.
   (b) If the controller circuit determines from the door contact sensor that the door is not closed, then the controller circuit gives the lock user two more chances to close the door and press the lock key. If, after the lock key is pressed two more times, the door is not closed, the controller circuit actuates the alarm.
(6) If the door is not locked within a preset time after a valid entry code is entered, the controller circuit actuates the alarm.

The series of steps set out above may be modified while remaining within the scope of the invention. For example, the number of attempts allowed to open the enclosure or to close the enclosure after the delivery before the alarm is actuated may be varied. The goal is that the lock user should be prevented from accidentally causing the locking bolt to latch before the door is fully closed and from forgetting to close the door and press the lock key before leaving. If necessary, additional indicators may be added to assist the lock user. For example, the lock key on the keypad might flash while the door is open after the lock key has been pressed and when the door is closed but not locked. In addition, the number of locks, lock users, lock managers, lock entry retrieval server, or PC software could be modified to include one or a plurality of locks, lock users, lock managers, lock entry retrieval server, or PC software.

While it is preferable to include the door contact sensor and alarm in the enclosure and to include the steps involving them in the process to be followed in delivering an item to the enclosure, the enclosure may be used without either of those elements. Their omission would lessen the security of the system, but if the lock user is careful, successful entries can be made, provided that the entry code is obtained or generated and communicated to the lock user.

In one embodiment, the locking mechanism comprises a motor-driven bolt and a bolthole, such as a motor-driven deadbolt mechanism available from Weiser Lock. The door can be opened by entering an entry code into a keypad to provide access to interior of the moveable enclosure. The keypad may be a numeric keypad having an enter and a lock key. However, the lock may be any type of lock such as a J-Hook lock produced by E. J. Brooks for roll-up doors. In addition, the keypad may also be an alphanumeric keypad, such as that typically found on a computer keyboard.

In additional embodiments of the invention, the entry codes may be set or reset by a variety of methods. The simplest method of resetting the entry code is analogous to the manner in which a conventional garage door opener entry code is reset—switches connected to the controller circuit are moved to new positions. This could be performed by an individual person in, on or around the moveable enclosure, or performed by artificial intelligence in, on or around the moveable enclosure. Other methods of resetting the entry code include: to have a new entry code set through the keypad itself (such as using a special reset code to preface the new entry code), a separate keypad, a circuit for receiving a new entry code from an external source, or a circuit for generating a new entry code (for example, each circuit may be a programmable micro-controller or may be embodied in discrete electronic circuit elements). It is preferred that some mechanical or electronic element is provided for erasing, editing, changing or adding entry codes. These methods could be available either at the lock or distant from the lock in time and/or space. Depending upon how the controller circuit is set up, a code entered could substitute a new entry code for an existing entry code, and/or it could add a new code to a stored list of entry codes, any of which would unlock the lock in the moveable enclosure. In addition, the lock may contain a mechanical backup, an electronic backup, or some combination of the two to the system.

In an additional embodiment, the system and method of the present invention may be used to provide deliveries of items to moveable enclosures, or to allow for the provision of services to one or a plurality of moveable enclosures. The items delivered or services performed could be delivered or provided to the enclosure itself, or to any component of the moveable enclosure, whether within, on, or in the vicinity of the moveable enclosure.

In an additional embodiment, the placing of an order for goods or services, generally referred to as a shopping cart, is tied to the generation of entry codes for the movement of goods in moveable enclosures. This feature allows for the integration of the PC software with the shopping cart. When the shopping cart is being completed, the entry code is created, either automatically or manually, and communicated to the lock user and the moveable enclosure. Alternatively, when the entry code is being created, the order for the goods or services can be placed. This feature may also be tied to inventory management or fleet management. For example, the integrated software and shopping cart is used to predict sales, which allows the company to set its requirement for moveable enclosures (e.g., delivery trucks) with appropriate entry codes for entering the truck and for starting the truck. The delivery trucks are used to pick up additional inventory from suppliers and to deliver the anticipated sales. This feature can also be integrated with the inventory management process and related systems.

In an additional embodiment, the PC software confirms that the lock user has received the entry code and that the lock has received the entry code, thereby ensuring that when the lock user arrives to use the lock that the lock will have the lock user's entry code.

The setting of entry codes generated by the PC software may be manually generated, automatically generated, or based on a selection by the lock user. Thus, the entry codes may be created in several ways.

In an embodiment that is especially useful when a high level of security is desired, more than one entry code may be required in order for the lock to release on the moveable enclosure. For example, a lock manager may assign a personal lock entry code for a lock user. The lock manager then may also create a shipment code for all entries related to that particular shipment. In order for the lock user to enter the moveable enclosure in this example, the lock user must use both his personal lock entry code as well as the shipment code. These codes may be set up to be entered in a predetermined order, or the codes may be set up to be acceptable in any order.

By establishing communication between the purchaser's PC and the lock controller, the setting of an entry code and the providing of the entry code to the lock user can be automated. The following describes a process in which the new entry codes are generated by the PC software:
(1) A purchaser, while browsing the Internet using conventional browser software such as Internet Explorer loaded onto his PC, comes upon a site of a business offering an item for sale, for which the purchaser decides to place an order. The software serving the pages of the website is running on the server and is conventional server software used by electronic commerce sites (e.g., business to business, business to consumer, business to government, or any other variations of business, government, consumer and employee) that includes an order form. An addition to the order form includes the ability for the user to provide or generate an entry code, communicate it to the lock and/or the lock user, and complete the transaction on the server. For example, the software running on the server may be modified to provide a text box for the user to fill in with the entry code and submit.
(2) The purchaser clicks a button, fills in a form, or takes some other action that alerts the server that the purchaser wishes to place an order for the item.
(3) The server determines whether the PC has loaded the proper software for communicating with the lock on the moveable enclosure (such as the delivery van) and whether the PC software is actually in communication with the lock on the moveable enclosure. To make these determinations, the user may be asked to answer one or more questions. Alternatively, the server may have previously sent a cookie to the PC to indicate that the software and communication connection are present, in which case the ordering request sends the cookie indicating the presence of the lock on the moveable enclosure and software to the server, and then the server merely asks the user whether the lock on the moveable enclosure is still connected. In fact, the connection may not always be on. In this case the PC stores or buffers the information to communicate with the lock on the moveable enclosure the next time it is connected.
(4) If the server establishes that the PC can communicate with the lock on the moveable enclosure, the server requests that the PC software generate a new entry code and send the code back to the server to include with the order information. The user never has to manually input an entry code. Hence, the obtaining and providing of the entry code to the lock user is transparent to the purchaser.

As an alternative to the above-described process, entry codes may also be generated at the lock and/or at the server and then sent to the lock controller. The entry code may be generated in hardware or in software using well-known algorithms.

The lock controller circuit may contain discrete electronics that are capable of generating new entry codes, storing one or a plurality of entry codes, and/or erasing a code after a single use. It may contain a random number generator, storage, and/or be programmable to carry out any one or all of the functions or any combination of the functions described above.

Entry codes generated by PC software may be stored on the PC, in the lock controller, at the server, or all of the above for reporting and tracking or for any other purpose relating to the transaction.

The above-described process for generating new entry codes using the PC software is designed upon an assumption that the purchaser will be ordering from a PC connected directly by a wire line or wireless connection to the lock on the moveable enclosure and connected to the server via the Internet. A further enhancement to this process includes a situation where the purchaser that wishes to place an order is doing so from a remote location using a remote PC that is connected to the Internet or another communications network. In this case, the purchaser's PC must be connected to the Internet at the same time and be accessible to the purchaser from the remote PC. This may require that the purchaser's PC have a static IP address or an IP address that can be determined in some way by the remote PC. Alternatively, another method may be used to determine the location of the purchaser's PC on a network such as a private network or the Internet. Assuming that the network location of the purchaser's PC can be determined, the process that occurs when the user wishes to place an order is similar to that described above. The only difference is that the remote PC in effect acts as a relay between the server and the purchaser's PC.

The communication between the purchaser's PC and the server takes place through the remote PC. The software on the remote PC and the purchaser's PC need not be modified. However, the server must be loaded with software to enable the relaying function of the remote PC by establishing communications with the purchaser's PC. Such communication may be established before an order form is submitted to the server, or as soon as the server attempts to communicate with the purchaser's PC software. In so doing, the relaying software should obtain the IP address of the purchaser's PC if it does not already have it, then establish a connection with the purchaser's PC, and provide any necessary data (e.g., user name and password) to the purchaser's PC software to allow the remote PC to download and/or run software and/or use the purchaser's PC remotely when interacting with the server. There are several ways in which this function can be implemented, as will be understood by those skilled in the art. One example of such an implementation is to load the software on the remote PC.

In another embodiment involving the use of a remote PC, the server has requested an entry code during the transaction and the request reaches the purchaser's PC, and the balance of the communication regarding the entry code takes place directly between the purchaser's PC and the server. In other words, the primary function of the remote PC is to start the entry code generation process by placing the order.

The remote PC and/or the purchaser's PC may be a standard computer, or any variety of other wired or wireless devices such as a PDA or a cell phone. For example, a cell phone's electronic serial number may be used as a user name and a password may be keyed into the cell phone keypad to gain access to the remote PC, the purchaser's PC, or the server to complete the above transaction.

More generally, the system and method of the present invention may be applied to any enclosed space having a door with a lock that can be opened by a combination that can be reset. Thus, the moveable enclosure can be practically any open air, completely enclosed, or sealed space that moves by itself, under the control of someone or something, or by connecting to anything that can move it, and/or any combination of the above.

For example, suppose an airplane is considered to be the moveable enclosure, and the locking mechanism is a motor-driven deadbolt lock capable of locking and unlocking an entrance door by entering a code at a keypad located at the door or a Bluetooth™ device that can unlock and open the door to the airplane. The lock manager that is operating the PC software may be a business that arranges services, such as cleaning or maintenance services for the airplane. The setting of the time for the entry code may be based upon the flight schedule, and the setting of the location may be based on the airport at which the plane is scheduled to be temporarily resident. Thus, instead of delivering an item to the moveable enclosure, the lock user is a service provider that uses the location and/or time-based code to perform a service on the airplane (i.e., the moveable enclosure). By changing the code after each entry, airplane security would be improved, as the service provider would not have a physical key or swipe card that could be misused or a reusable entry code. This process may be applied to the holding area where those that perform the service meet prior to proceeding to the airplane, such as a truck with food carts, or a Jetway to enter the plane, or the baggage area in an airport. In addition, this feature may be applied to opening the containers that hold the baggage or other cargo that is carried to or from an airplane, or to the individual baggage pieces themselves.

As a second example, the PC software may communicate via a communications network with a remote device capable of transmitting the entry code required to open a valve on an oil tanker truck. This lock on the valve on the moveable enclosure of the truck is set by the lock manager to open only for the lock user (i.e., the driver) at the predetermined GPS location of the pumping/batch gathering station. In addition, the pumping/batch gathering station may have a lock on its valve that also has an entry code generated by the lock manager PC software. This second entry code may be generated based on the time and/or as a single use code. This ensures that the pick up or delivery of oil and gas product occurs only to the correct truck, only at the correct time, and only at the correct pumping/batch gathering station by only the correct lock user.

In addition, the entry code may be used to lock out access to controls. One example of this is the use of a panic button on an airliner. During an attempted hijacking, the pilot hits the panic button that disconnects (i.e., locks out) the controls and activates the autopilot. Only with a new code from the ground controller's PC software can the controls be reactivated (i.e., lockout of the controls removed), thereby disengaging the autopilot. Such a system would prevent the use of an airplane as a guided missile, for example, in the manner as what happened on Sep. 11, 2001. Another example applies to fleets of vehicles used by pipeline inspection companies. In this exemplary situation, the vehicles have their ignition keys removed and replaced with keypads and starter buttons. The starter button does not engage the starter unless and until the correct entry code is entered into the keypad. Thus, the fleet manager can determine which lock user (i.e., driver) is able to operate which moveable enclosure (i.e., vehicle). The lockout of access to controls can be applied to any set of controls on any moveable enclosures.

A system according to the present invention may be integrated with asset management software to ensure efficient movement of goods and provision of services. For example, a lock system may be used to ensure that a semi truck may be connectable only to a specific trailer. Thus, the correct driver, the correct truck, and the correct trailer can be ensured.

In another exemplary situation, a shipment system can track an envelope or package to ensure that the package is placed into the correct shipment container and on the correct truck or other transport vehicle. Thus, fleet management, fleet security, packaging, and load management can be integrated. For example, the system can be used to determine when a truck is full, and then allocate another truck or other vehicle for the package, including ensuring that the correct vehicle operator and the correct new vehicle are being employed.

In another exemplary situation, a lock manager visits a website using his cellular telephone. The lock manager enters his user name and password, or other authenticating information, such as a personal identification number (i.e., PIN). The lock manager then creates a new entry code for a lock user. The website communicates with the PC software and downloads the new entry code and instructions. Then, the PC software sends the new entry code to the appropriate lock control circuit so that the lock user can open the lock. Alternatively, the lock manager can use any appropriate means of accessing the website in place of his cellular telephone.

In another embodiment of the present invention, the climate and/or environment of the interior or exterior of the moveable enclosure, or the surface temperature of the enclosure, can be integrated with the lock system. For example, if the interior of a refrigerated trailer registers a certain temperature on a sensor located inside the trailer, the lock manager may be prompted to generate an entry code for the driver to open the refrigerator unit on the moveable enclosure in order to adjust the thermostat setting.

In another embodiment, a motion detector system can be integrated with the lock system of the present invention. For example, a boxcar that includes a motion detector may detect that the boxcar was “humped” (i.e., the car moved down a sloped track and collided into another boxcar in a lineup). This detection event then prompts the lock manager to generate an entry code to allow a user to inspect the interior of the humped boxcar. Alternatively, the detection event may cause the entry code to be automatically generated.

In another embodiment, a driver evaluation system can be integrated with the lock system of the present invention. For example, when a truck driver speeds or revs the engine too high, a demerit may be given, and then when a certain threshold number of demerits are given to a particular driver, the system may prompt the lock manager to prevent further driving by that driver by changing the entry code required for access to the controls of the truck.

As another example, a tire pressure system can be integrated with the lock system of the present invention. A tire pressure sensor may inform a truck driver that a tire is either underinflated or overinflated. The truck driver may control the tire pressure through an electronic system in his truck. Thus, in this instance, the truck driver may obtain an entry code from a lock manager to obtain access to the electronic system, thereby enabling him to adjust the tire pressure. Therefore, the present invention is well-suited to integration with any type of existing system that is used with a moveable enclosure.

In another embodiment, the system of the present invention can bypass the need of the lock user to learn the entry code by enabling the lock manager to directly enter the entry code remotely, thereby opening the lock directly. This feature is useful when the lock user is unable to obtain the entry code via a secure channel. For example, if a lock user does not have access to the Internet, the lock user may call the lock manager on the telephone and request that the lock be opened directly. The lock manager may elect to orally inform the lock user of the entry code, or, if the lock manager prefers for security or other reasons, he can simply enter the entry code and open the lock remotely for the lock user.

While the present invention has been described with respect to what is presently considered to be the preferred embodiment, it is to be understood that the invention is not limited to the disclosed embodiments. To the contrary, the invention is intended to cover various modifications and equivalent arrangements included within the spirit and scope of the appended claims. For example, the above descriptions of embodiments of the invention are couched in terms of using personal computers. Those skilled in the art will understand that handheld wireless devices, such as watches, jackets, or implanted recognition chips may also be used. Similarly, the communication components may be wired or wireless, including 802.11, Bluetooth™, category 5 cables, satellite, cellular, radio transceiver, bar codes, RF signatures, enhanced brain waves, or other wireless communication methodologies. A significant objective of the invention is to integrate with other related systems, either as the central control of the other related systems (i.e., acting as the integrated quarterback), or as a subcomponent of the other related systems (i.e., acting as an add-on). The scope of the following claims is to be accorded the broadest interpretation so as to encompass all such modifications and equivalent structures and functions.

The contents of U.S. Pat. No. 5,917,411 and U.S. application Ser. No. 09/617,760 are incorporated herein by reference.

1. A security system for controlling access to a moveable enclosure, comprising:
a lock on the moveable enclosure;
a control circuit coupled to the lock and configured to i) receive an entry code and ii) open the lock in response to receipt of the entry code;
a Global Positioning System device coupled to the control circuit and configured to generate latitude and longitude data relating to the moveable enclosure; and
a personal computing device wirelessly coupleable to the control circuit and configured to generate the entry code using GPS latitude and longitude data.

2. The system of claim 1, wherein the control circuit is further configured to use the latitude and longitude data to determine a physical location of the moveable enclosure, and to open the lock only when the determined physical location is within a predetermined region.

3. The system of claim 1, wherein the control circuit includes a clock that is configured to provide data relating to the time, and wherein the control circuit is further configured to open the lock only during a predetermined time interval.

4. The system of claim 1, wherein the control circuit is further configured to erase the entry code after the lock has been opened a single time, such that if the entry code is received a second time, the lock will not be opened.

5. A security system for controlling access to a moveable enclosure, the system comprising:
a lock on the moveable enclosure;
a control circuit coupled to the lock and configured to i) receive an entry code and ii) open the lock in response to receipt of the entry code;
a location sensor coupled to the control circuit and configured to generate data relating to a location of the moveable enclosure; and
a personal computing device wirelessly coupleable to the control circuit and configured to generate the entry code using the location data.

6. An apparatus for opening a lock on a moveable enclosure, comprising:
a device, coupled to the moveable enclosure, to open the lock;
a GPS device, coupled to the moveable enclosure, to output information corresponding to the location of the moveable enclosure; and
a lock device, coupled to the moveable enclosure, for barring the opening of the lock until the GPS device outputs information indicating that the moveable enclosure is at a predetermined location.

7. A method of controlling access to a moveable enclosure, the method comprising the steps of:
locking the moveable enclosure using a digital remote control lock;
connecting a control circuit to the lock, the control circuit being configured to open the lock upon entry of a valid entry code by a user;
determining geographical location data about a physical location of the moveable enclosure using a GPS sensor;
generating an entry code using GPS data; and
communicating the entry code to the control circuit.

8. The method of claim 7, further comprising the step of, when the entry code has been entered by the user into the control circuit and the lock has been opened, reconfiguring the control circuit so that the entered entry code is no longer valid.

9. The method of claim 7, further comprising the step of determining the entry code entered by the user to be invalid when the determined geographical location data indicates that the physical location of the moveable enclosure is not within a predetermined region.

10. The method of claim 7, further comprising the steps of:
tracking a time at which the entry code is entered using a clock; and
determining the entry code entered by a user to be invalid when the tracked time is not within a predetermined time interval.

11. An apparatus for controlling access to a moveable enclosure, the apparatus comprising:
a locking means for preventing access to the moveable enclosure;
a control circuit means for opening and closing the locking means, the control circuit means being configured to i) receive an entry code and ii) open the locking means in response to receipt of the entry code;
a location sensing means for generating data relating to a physical location of the moveable enclosure, the location sensing means being coupled to the control circuit means; and
a computing means for generating the entry code using the generated data, the computing means being in communication with the control circuit means.

12. The apparatus of claim 11, wherein the location sensing means comprises a GPS device.
